(19) United States
(12) Patent Application Publication
(10) Pub. No.: US 2011/0189364 A1
(43) Pub. Date: Aug. 4, 2011

(54) ROTARY BAKING SYSTEM AND METHOD

(76) Inventor: Wassie Mulugeta, Hamilton (CA)

(21) Appl. No.: 13/010,999

(22) Filed: Jan. 21, 2011

Related U.S. Application Data
(60) Provisional application No. 61/300,218, filed on Feb. 1, 2010.

(51) Int. Cl. A21B 1/44; A21D 8/06

(52) U.S. Cl. 426/505; 99/423

(57) ABSTRACT

The present device is a rotary bake table which includes an indexing circular rotary table indexable at preselected intervals. The rotary bake table further includes a plurality of baking stations evenly mounted around and proximate the outer diameter of the rotary table wherein each baking station includes a baking surface; a heater for heating each baking surface; a batter dispenser for dispensing batter onto the baking surface wherein the batter dispenser including a dispensing head with a plurality of apertures for evenly filling the baking surface with batter.

This application claims priority from previously filed U.S. provisional application No. 61/300,218 filed Feb. 1, 2010 by Wassie Mulugeta under the title ROTARY BAKING SYSTEM AND METHOD

### FIELD OF THE INVENTION

The present invention relates to method for baking bread and in particular flat bread and in particular relates to a rotary baking system and method for baking flat breads.

### BACKGROUND OF THE INVENTION

Flat breads in particular pita and injera type breads are becoming more popular particularly in restaurant settings. The increasing demand for flat breads, pitas and injeras creates a need for having a device which can quickly and inexpensively bake these types of breads in higher quantities.

The present device a rotary baking system and method for producing flat breads, pitas and injeras allows one to quickly and efficiently prepare and bake large amounts of flat breads, pitas and/or injeras over a very short period of time.

### BRIEF DESCRIPTION OF THE DRAWINGS

The present invention will now be described by way of example only with reference to the following drawings in which:

FIG. 1 is a top plan view of the rotary bake table showing the baking surfaces.

FIG. 2 is a schematic side elevational perspective view of the rotary bake table showing the gas burners.

FIG. 3 is a schematic side elevational perspective view of the rotary bake table showing the cooking surfaces.

FIG. 4 is a side elevational perspective schematic view of the rotary bake showing the cooking surfaces covered with lids.

FIG. 5 is a side schematic perspective view of a batter dispenser for use in association with the rotary bake table.

FIG. 6 is a partial exploded view of the batter dispenser showing the dispensing head in more detail.

FIG. 7 is a schematic top perspective view of the rotary bake table together with the batter dispenser.

FIG. 8 is a schematic side elevational perspective view of the rotary bake table together with the cam guide in place for placing the lids in the closed position.

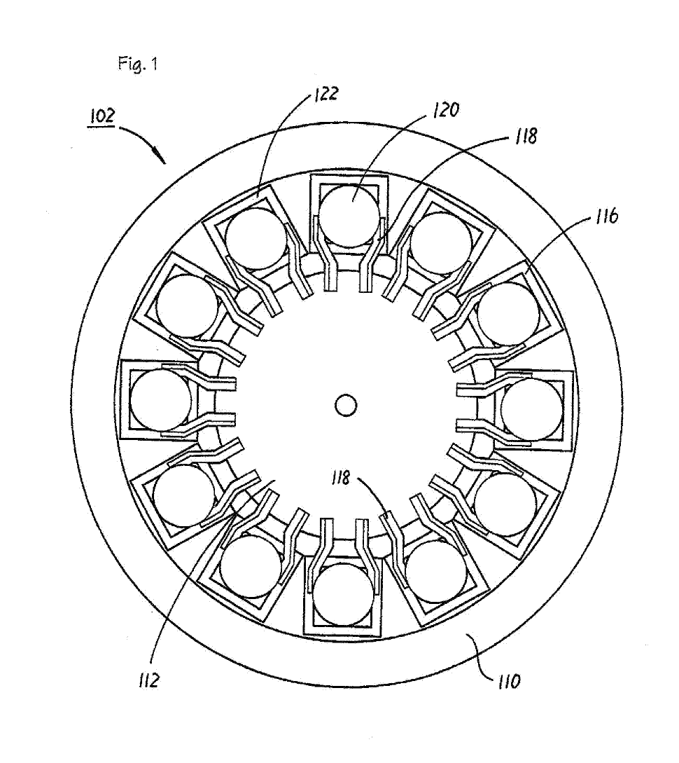

### DETAILED DESCRIPTION OF THE PREFERRED EMBODIMENT

The present device a rotary baking system and method for producing flat breads includes the following major components namely rotary bake table 102 used in association with batter dispenser 104.

First of all to rotary bake table 102 includes the following major components namely outer stationary table 110 having mounted therein an inner rotary table 112, the rotary table 112 having mounted thereon baking stations 116 using mounting brackets 118. Each bake station 116 includes a baking surface 120 and a burner frame 122.

Rotary bake table 102 includes gas burner 130 underneath of each of the baking surfaces 120 in order to heat the baking surface 120. Stationary table 110 includes a top 132 and a table frame 134 which is held up with table legs 136. Gas piping 138 is routed underneath of stationary table 110 to feed gas to each gas burner 130.

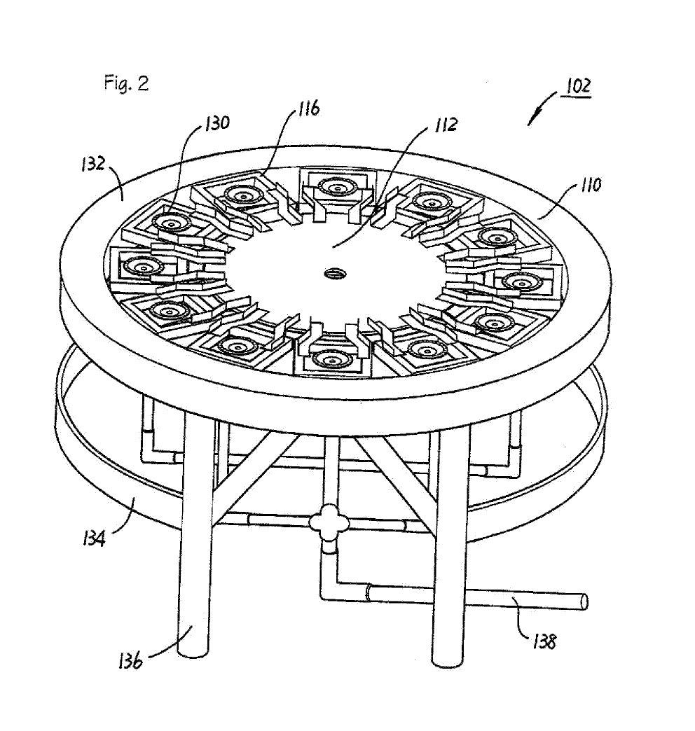

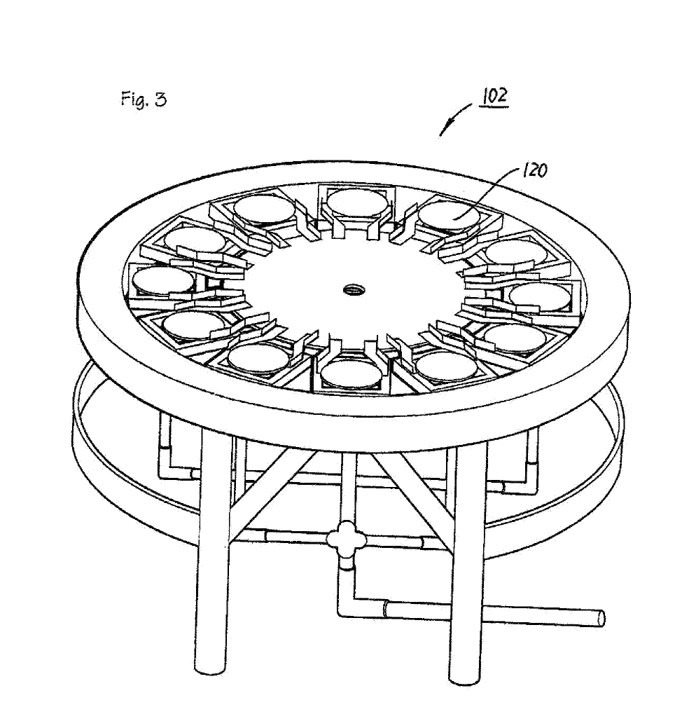

FIG. 2 shows the rotary bake table 102 with the gas burners 130 exposed. FIG. 3 shows the rotary bake table 102 having baking surfaces 120 mounted over top of each gas burner 130.

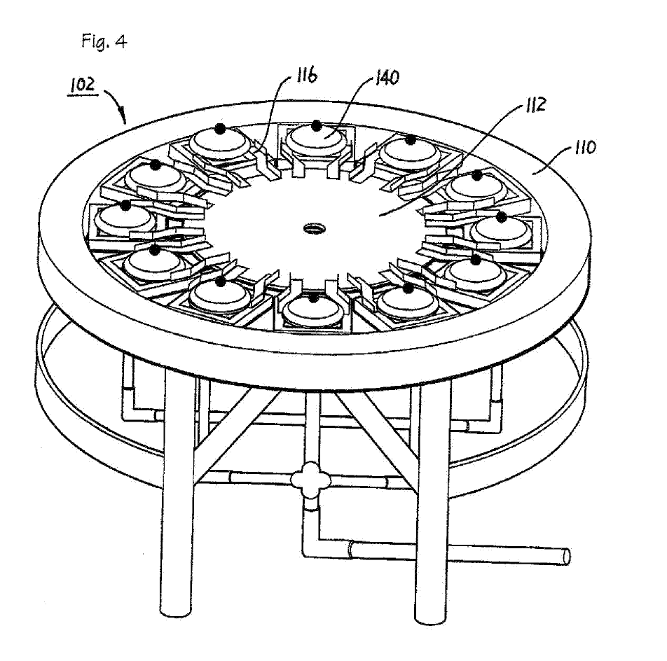

FIG. 4 shows rotary bake table 102 having mounted overtop of each baking surface 120 a lid 140 for containing the heat while the flat bread is being baked on baking surface 120.

Referring now to FIGS. 5 through 8, FIG. 5 for example shows batter dispenser 104 which includes the following major components namely stand 150, electronic controls 152, legs 154, a cross-member 156, pneumatic cylinder 158, a hopper 160 containing the batter 162 and a batter conduit 164 communicating batter to dispensing head 166.

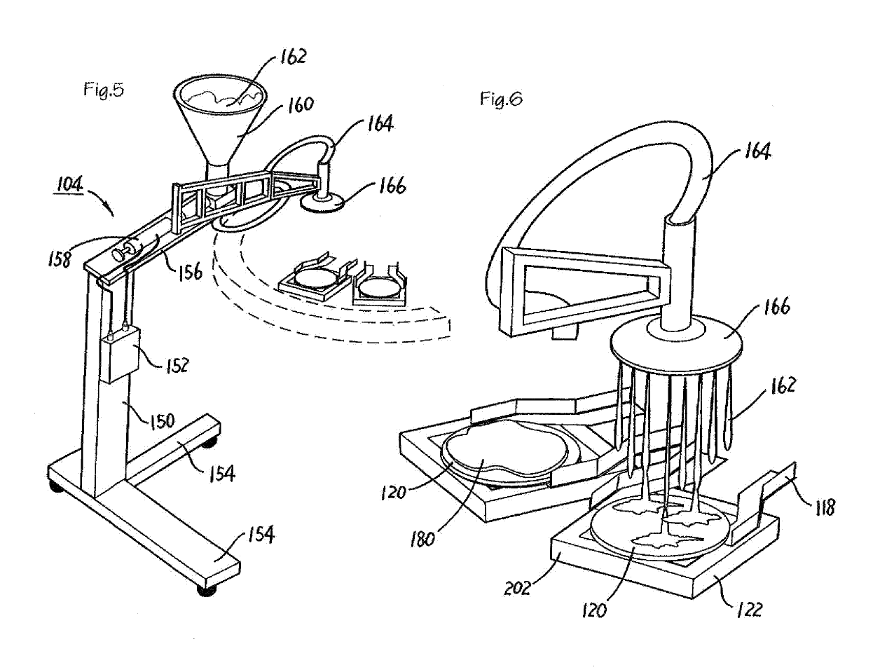

Referring now to FIG. 6 which is a partial exploded view of dispensing head 166 together with batter conduit 164, one can see that batter 162 emanates from dispensing head 166 through numerous apertures in dispensing head 166 similar to a shower head for dispensing water. Batter 162 flows downwardly in droplets and/or columnar fashion as shown in FIG. 6 thereby filling baking surface 120 with flat bread 180 with a predetermined amount of batter 162.

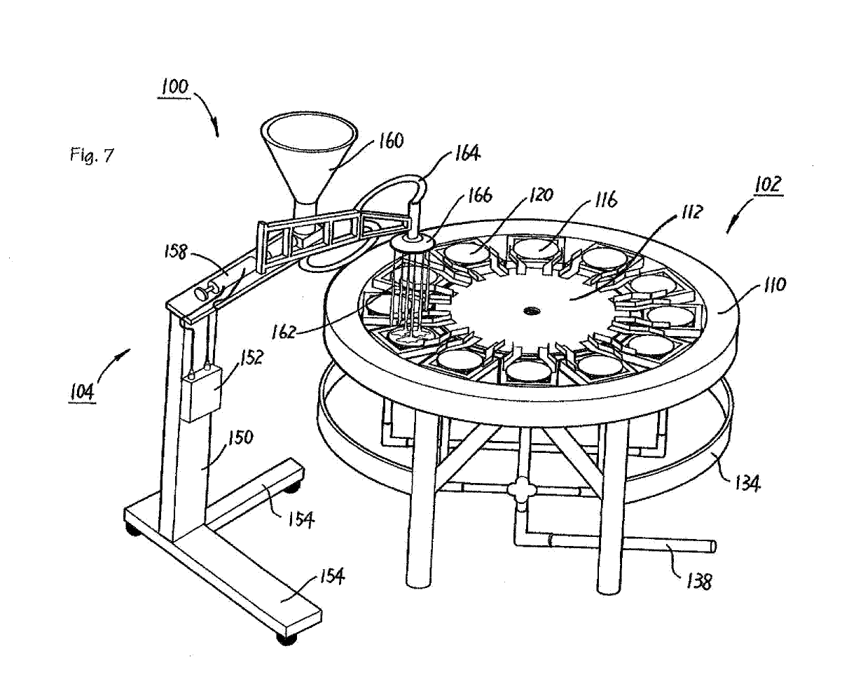

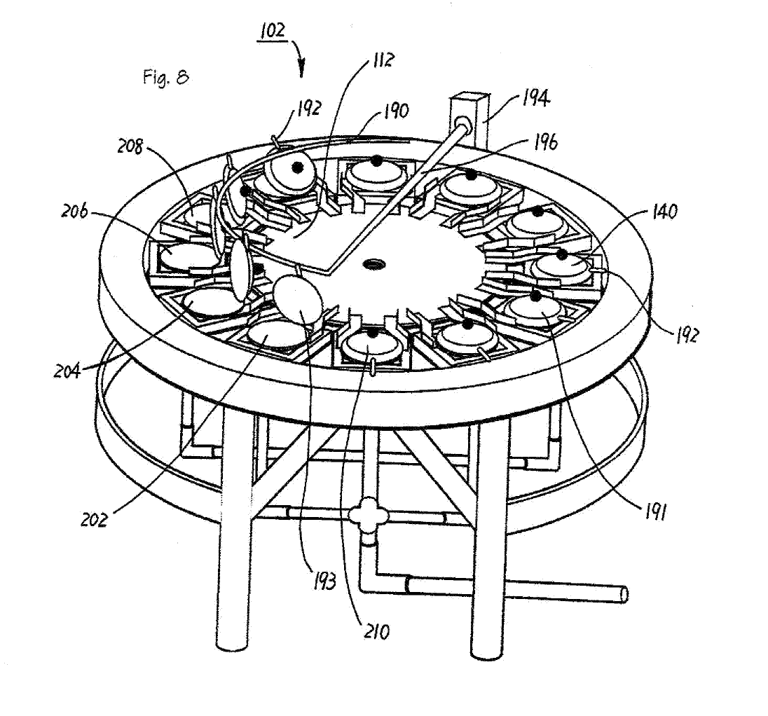

Referring now to FIGS. 7 and 8 as well rotary table 102 also includes a guide cam 190 and each lid 140 includes a cam follower 192. Guide cam 190 is supported by a guide member 196 which is rigidly affixed to a guide support 194. As rotary table 112 rotates clockwise, the guide cams 190 of each lid 140 impinges upon guide cam 190 thereby depressing the cam follower 192 down such that lids 140 are eventually placed into a closed position 191. Initially when the machine is started all of the lids are placed in the open position as shown as 193. Guide cam 190 is a curved horizontally disposed rod of increasing diameter for closing lids 140 as rotary table 102 indexes.

Batter 162 is dispensed onto baking surface 120 at station 1 which is shown as 202 in FIG. 6 as well as in FIG. 8. As rotary bake table 102 turns clockwise, each subsequent station namely station number 2 shown as 204 in FIG. 8 and station number 3 as shown as 206 in FIG. 8 and station 4 shown as 208 in FIG. 8 progressively impinge more upon guide cam 190 until the cam follower 192 is depressed to the point where each lid 140 is then placed into closed position 191. Once the baking station 116 arrives at station 12 shown as 210, the lid 140 is manually opened by an operator and the completed and baked flat bread is removed from the baking surface 120.

In use the rotary baking system and method for baking flat bread goes through the following steps.

Step one, gas burners 130 are turned on and lids 140 are placed into the open position shown as 193.

Step two, gas burners 130 are left on until the baking surface 120 is brought to a pre-selected temperature.

Step three, hopper 160 is filled with batter 162 in order to initiate the batter dispensing mechanism 104.

Step four rotary table 112 indexed such that at station 1, shown as 202 the first batter 162 can be dispensed onto baking surface 120.

Step five, the controls 152 of batter dispenser 104 are activated such that pneumatic cylinder 158 which is of the plunger type releases or forces a pre-determined amount of batter 162 through batter conduit 164 and out through dispensing head 166 which then deposits the batter 162 onto baking surface 120.

Step six, rotary table 112 of rotary bake table 102 indexes by one station such that former station 1, 202 now moves to station 2, 204 whereby the guide cam 190 impinges upon cam follower 192 thereby initiating closure of each of the lids 140.

Step seven, steps five and six are repeated indefinitely.

By the time the rotary table 112 has indexed four positions namely such that the initial station 1 now is at the location of station 4, shown as 208, the lid 140 would be in the totally closed position 191.

As each baking station 116 arrives at position station 1, 202 the batter dispenser 104 is programmed to release a pre-determined amount of batter 162 through dispensing head 166 and onto the baking surface 120 which is currently at the station 1 shown as 202 position.

Step Eight the baking station 116 travels from station 1, position 202 all the way around to station 12, position 210, the lid 140 is manually opened by an operator and the baked flat bread is removed from the baking surface 120 and the process repeats itself.

In practice the inventor has determined that the indexing time of rotary table 112 is approximately 10 seconds which is the time needed to dispense batter 162 out of dispensing hand 166 and index the baking station 116 from station 1 position 202 to station 2 position 204. The indexing mechanism is not shown in the drawings, however any known system or method in the art which is adaptable to this configuration will be suitable to index (rotate rotary table 112) a pre-selected distance at a time.

In addition the inventor has found that the baking surfaces preferably are approximately 15-16 inches in diameter and are adapted for baking flat breads, pitas and injera.

It should be apparent to persons skilled in the arts that various modifications and adaptation of this structure described above are possible without departure from the spirit of the invention the scope of which defined in the appended claim.

I claim:

1) A rotary bake table comprising:
a) an indexing circular rotary table indexable at preselected intervals;
b) a plurality of baking stations evenly mounted around and proximate the outer diameter of the rotary table wherein each baking station includes a baking surface;
c) a heater for heating each baking surface;
d) a batter dispenser for dispensing batter onto the baking surface wherein the batter dispenser including a dispensing head with a plurality of apertures for evenly filling the baking surface with batter from above the baking surface.

2) The rotary bake table claimed in claim 1 wherein each baking station further including a lid for covering the baking surface such that the lid moveable between an open position and a closed position.

3) The rotary bake table claimed in claim 2 further includes a guide cam cooperatively engaging with a cam follower attached to each lid for closing the lids as the rotary table is rotated.

4) The rotary bake table claimed in claim 3 wherein the guide earn includes a curved horizontally disposed rod of increasing diameter for closing lids as rotary table indexes.

5) The rotary bake table claimed in claim 1 further includes a round stationary table disposed around the outer periphery of the rotary table for mounting the rotary table there to.

6) The rotary bake table claimed in claim 1 wherein the heater including a gas burner.

7) A method for baking flat breads with the rotary bake table claimed in claim 1 including the following steps:
a) turn on heaters and place lids into the open position;
b) bring baking surfaces to preselected temperature;
c) release preselected amount of batter from dispensing head onto a first baking surface;
d) index the table a preselected amount such that the next baking surface is aligned with the dispensing head and can be filled with batter;
e) remove the baked product from the baking surface of each baking surface as it arrives adjacent the batter dispenser;
f) continue with steps c, d, and e.
